(19) United States
(12) Patent Application Publication
(10) Pub. No.: US 2004/0080618 A1
(43) Pub. Date: Apr. 29, 2004

(54) Smart camera system

(76) Inventors: Timothy Sweyn Norris, Essex (GB); Michael Black, Cambridge (GB); Andrew Dickinson, Leicestershire (GB)

Correspondence Address: Thomas M Galgano, Galgano & Burke, Suite 135, 300 Rabro Drive, Hauppauge, NY, 11788, US

(21) Appl. No.: 10/416,868

(22) PCT Filed: Nov. 20, 2001
(86) PCT No.: PCT/GB01/05118

(30) Foreign Application Priority Data
Nov. 20, 2000 (GB) 0028162.6

(51) Int. Cl. H04N 5/262

(52) U.S. Cl. 348/207.1; 348/239

(57) ABSTRACT

There is provided a smart camera (20) including: (a) a pixel sensor (110); (b) optical imaging means (100) for projecting an image of a scene onto the sensor (110) to generate a sensor signal representative of the scene; (c) processing means (120, 140) for processing the sensor signal to identify whether or not one or more events occur within the scene and for outputting an output signal indicative of occurence of one or more of the events to a communication channel coupled to the processing means. The camera (20) is deitinguished in that it includes communication means (30, 130) for remotely updating at least one of operating parameters and software of the processing means (120, 140) for modifying operation of the camera for identifying the events.

### FIELD OF THE INVENTION

The present invention relates to a smart camera, and its uses, namely a camera with locally associated or in-built data processing hardware.

### APPLICANT'S KNOWLEDGE OF THE ART

Electronic cameras capable of receiving optical radiation from a scene, focussing the radiation to project an image of the scene onto a pixel-array image sensor, and generating at the sensor a signal corresponding to the image are well known. The image sensor can be a charge-coupled semiconductor device (CCD). In use, charges generated in response to received optical radiation are stepped along oxide layers in the sensor and thereby directed to readout circuits for outputting the signal. More recently, it has become increasingly common to employ complementary metal oxide semiconductor (CMOS) devices for image sensors because of their lower cost compared CCD devices and more convenient operating power supply requirements. However, CMOS image devices tend to suffer more inter-pixel radiation sensitivity variations in comparison to CCD imaging devices.

Recently, it has become common to connect such CMOS or CCD electronic cameras to personal computers (PCs) which are in turn connected to the internet. By such an arrangement, it is feasible to configure PCs to function as videophones and thereby enable video conferencing to take place between a plurality of PC users.

When electronic cameras are connected to PCs and employed as described above, it is convenient to configure the PCs to provide image compression, for example using well known JPEG or MPEG compression algorithms. By employing such compression, compressed data is conveyed via the internet or telephone network so that a relatively rapid image frame update rate can be achieved whilst not requiring costly high-bandwidth communication links. Other than providing such JPEG or MPEG image compression, the PCs do not perform any other form of image processing; such videoconferencing use does not warrant additional processing functions.

Increasingly, PC users have been employing CCD or CMOS cameras connected to PCs for remotely monitoring scenes via the internet. Such an arrangement enables a PC locally connected to an associated camera directed towards a preferred scene to be interrogated remotely from another internet site. Recently, several commercial businesses have commenced offering customers a service including hardware enabling the customers to view their domestic premises remotely, for example from work via the internet. The service is becoming increasingly popular in view of increasing frequency of burglaries and pets often being left indoors unsupervised. Moreover, the service also enables action to be taken in the event of serious problems, for example fire.

The inventors have appreciated that unauthorised intruders, for example burglars, can enter into domestic premises and cause considerable damage in a relatively short period of time, for example within minutes. Moreover, fires can spread rapidly in domestic properties on account of the amount of flammable material present; for example, studies have shown that a discarded cigarette stub can render a typical domestic living room an inferno within 5 minutes. Thus, at work, it is not possible for the aforesaid customers to monitor their premises continuously to take action in the event of burglary and/or fire unless they are inconveniently frequently using their PCs at work for this purpose.

Automated camera systems for monitoring smoke and fire are known, for example as described in an International PCT patent application no. PCT/GB01/00482. In this patent application, there is described a method of operating a computer for smoke and flame detection.

Although the method is optimised for flame and smoke detection, it is not easily adaptable to monitoring alternative events occurring within a scene.

The method described in the patent application is one amongst a myriad of image processing methods used in the art. Alternative methods are described in publications such as “Image Processing—The Fundamentals” by Maria Petrou and Panagiota Bosdogianni, published by John Wiley and Sons. Ltd., ISBN 0471-998834 and also in a publication “Pattern Recognition and Image Pmcessing” by Daisheng Luo, published by Horwood Publishing, Chichester, ISBN 1-898563-52-7. The inventors have found that methods of image processing described therein are insufficiently flexible for coping with a wide range of monitoring applications.

### SUMMARY OF THE INVENTION

According to a first aspect of the present invention, there is provided a smart camera including:

(a) a pixel sensor;

(b) optical imaging means for projecting an image of a scene onto the sensor to generate a sensor signal representative of the scene;

(c) processing means for processing the sensor signal to identify whether or not one or more events occur within the scene and for outputting an output signal indicative of occurrence of one or more of the events to a communication channel coupled to the processing means,

characterised in that the camera includes communicating means for remotely updating at least one of operating parameters and software of the processing means for modifying operation of the camera for identifying the events.

Such a camera is capable of having its operating parameters modified remotely and being adapted to cope with a range of automatic monitoring applications.

Preferably to ease signal processing requires, the processing means includes:

(a) filtering means for temporally filtering the sensor signal to generate a plurality of corresponding motion indicative filtered data sets; and

(b) analysing means for analysing the filtered data sets to determine therefrom occurrence of one or more events in the scene.

Removal of signal noise and categorising events effectively for analysis is important for rendering the camera reliable in use. Preferably, therefore, the processing means includes:

(a) threshold detecting means for receiving one or more of the filtered data sets and generating one or more corresponding threshold data sets indicative of whether or not pixel values within said one or more filtered data sets are greater than one or more threshold values; and

(b) clustering means for associating mutually neighbouring pixels of nominally similar value in the one or more of the threshold data sets into one or more pixel groups and thereby determining an indication of events occurring in the scene corresponding to the one or more pixel groups.

Alternatively, rather than executing temporal filtration followed by threshold detection and then clustering, the camera can be configured to execute threshold detection followed by threshold detection and then temporal filtration. Thus, the processing means then includes:

(a) threshold detection means for receiving the sensor signal to generate a plurality of image data sets and then to generate from said image data sets corresponding threshold data sets indicative of whether or not pixel values within the image data sets are greater than one or more thresh Id values; and

(b) clustering means for associating mutually neighbouring pixels of nominally similar value in the one or more threshold data sets into one or more pixel groups and thereby determining an indication of events occurring in the scene corresponding to the one or more pixel groups.

The inventors have appreciated that certain events occurring in a scene have certain characteristic frequencies of motion associated therewith. Preferably therefore to ease signal processing requires, the processing means includes:

(a) filtering means for temporally filtering one or more of the threshold data sets to generate a plurality of corresponding motion indicative filtered data sets: and

(b) analysing means for analysing the filtered data sets to determine therefrom occurrence of one or more events in the scene.

When the camera is employed in applications where subjects in the scene are moving, for example an intruder, it is desirable to track the movement in order to assist image recognition. Preferably, the camera then further comprises tracking means for tracking movement of said one or more groups within the scene and thereby determining one or more events indicated by the nature of the movement.

Certain subjects in the scene are recognisable by virtue of their aspect ratio. Preferably, therefore, the camera further comprises measuring means for measuring aspects ratios of said one or more groups to determine more accurately the nature of their associated event within the scene.

Other processing approaches can be applied to extract characteristic signatures associated with events occurring within the scene. Fast Fourier transform provides an effective method of extracting such signatures. Alternatively, Laplacian transform instead of, or in addition to, Fourier transform. Other types of transform for extracting spatial frequency can be employed. Preferably, therefore, the camera further comprises:

(a) transforming means for executing a spatial frequency transform on at least part of the threshold data sets and/or the filtered data sets to generate one or more corresponding spectra; and

(b) analysing means for comparing one or more of the spectra with one or more corresponding reference spectral templates to determine the nature of events occurring within the scene.

Often the camera cannot for any particular approach to signal processing adopted clearly identify events which are occurring within the scene. Preferably, therefore, the camera further comprising voting means for receiving a plurality of event indicating parameters in the processing means and determining one or more most likely events therefrom that are probably occurring within the scene.

More preferably, one or more of the operating parameters and software can be dynamically modified when the camera is in use.

Preferably, the camera further comprising modem interfacing means operable to communicate at intervals a signal through a single channel that the camera is functional, and to communicate for a relatively longer period through the single channel when one or more events are identified in the scene.

In the context of the invention, the word channel includes one or more of telephone lines, Ethernet, radio frequency wireless radio links, WAP telephone links, optical fibre waveguide links, ultrasonic wireless links and ADSL telephone lines.

When telephone lines are not restricted in number, it is desirable that the camera can function on a single bidirectional telephone line. Preferably, therefore, the interfacing means is operable to communicate at intervals a signal through a first channel that the camera is functional, and to communicate through a second channel when one or more events are identified in the scene.

Preferably, the sensor is a colour imaging device, and the camera is arranged to process pixel image data separately according to their associated colours.

According to a second aspect of the invention, there is provided a method of performing image processing in a smart camera according to the first aspect of the present invention, the method including the steps of:

(a) projecting an image of a scene onto a pixel sensor of the camera to generate a sensor signal representative of the scene;

(b) processing the sensor signal to identify whether or not one or more events occur within the scene and outputting an output signal indicative of occurrence of one or more of the events to a communication channel;

characterised in that the method further includes the step of:

(c) remotely updating at least one of operating parameters and software of the processing means as required for modifying operation of the camera for identifying the events.

According to a third aspect of the present invention, there is provided a method of transferring one or more of operating parameters and software to a camera according to the first aspect of the invention, the method comprising the step of remotely updating at least one of the operating parameters and software of processing means of the camera as required for modifying operation of the camera when identifying the events.

According to a fourth aspect of the present invention, there is provided a method of communicating between a smart camera according to the first aspect of the invention and a server site remote relative to the smart camera, the method including the steps of communicating a signal at intervals through a single channel to indicate that the camera is functional, and communicating the signal for a relatively longer period through the single channel when one or more events are identified in the scene.

According to a fifth aspect of the present invention, there is provided a method of communicating between a smart camera according to the first aspect of the present invention and a server site remote from the camera, the method comprising the step of communicating a signal at intervals through a first channel to indicate that the camera is functional, and to communicate the signal through a second channel when on or more events are identified in the scene.

According to a sixth aspect of the present invention, there is provided a smart camera system including a remote server for providing one or more of operating parameters and software, and one or more smart cameras according to the first aspect of the invention coupled to the remote server for:

(a) one or more of receiving the operating Parameters and the software from the server to determine camera operation; and

(b) monitoring a scene, the one or more cameras arranged to communicate to the remote server when one or more events occur within the scene.

It will be appreciated that features of the inventions described in the aspects above can be combined in any combination without departing from the scope of the invention as defined in the claims.

### DESCRIPTION OF THE DIAGRAMS

Embodiments of the invention will now be described, by way of example only, with reference to the following diagrams in which:

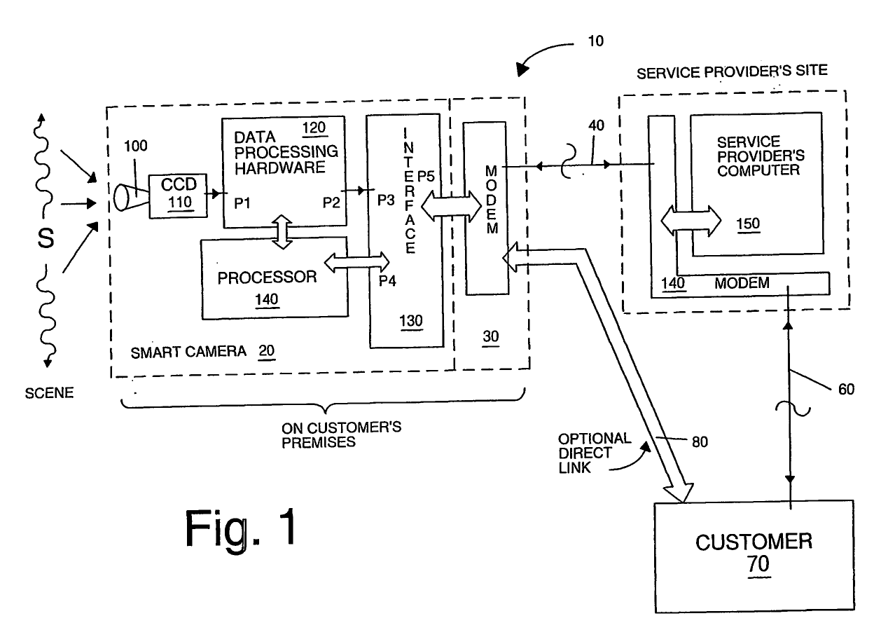

FIG. 1 is a schematic illustration of a smart camera system according to the invention, the system operable to automatically monitor a scene “S” and convey associated information to a respective customer,

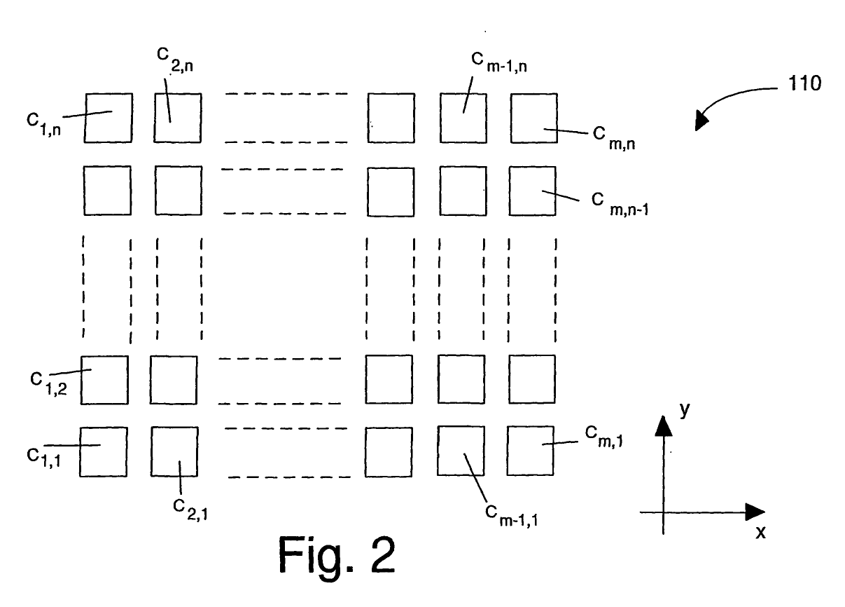

FIG. 2 is an illustration of a pixel layout arrangement for a sensor of a smart camera in FIG. 1;

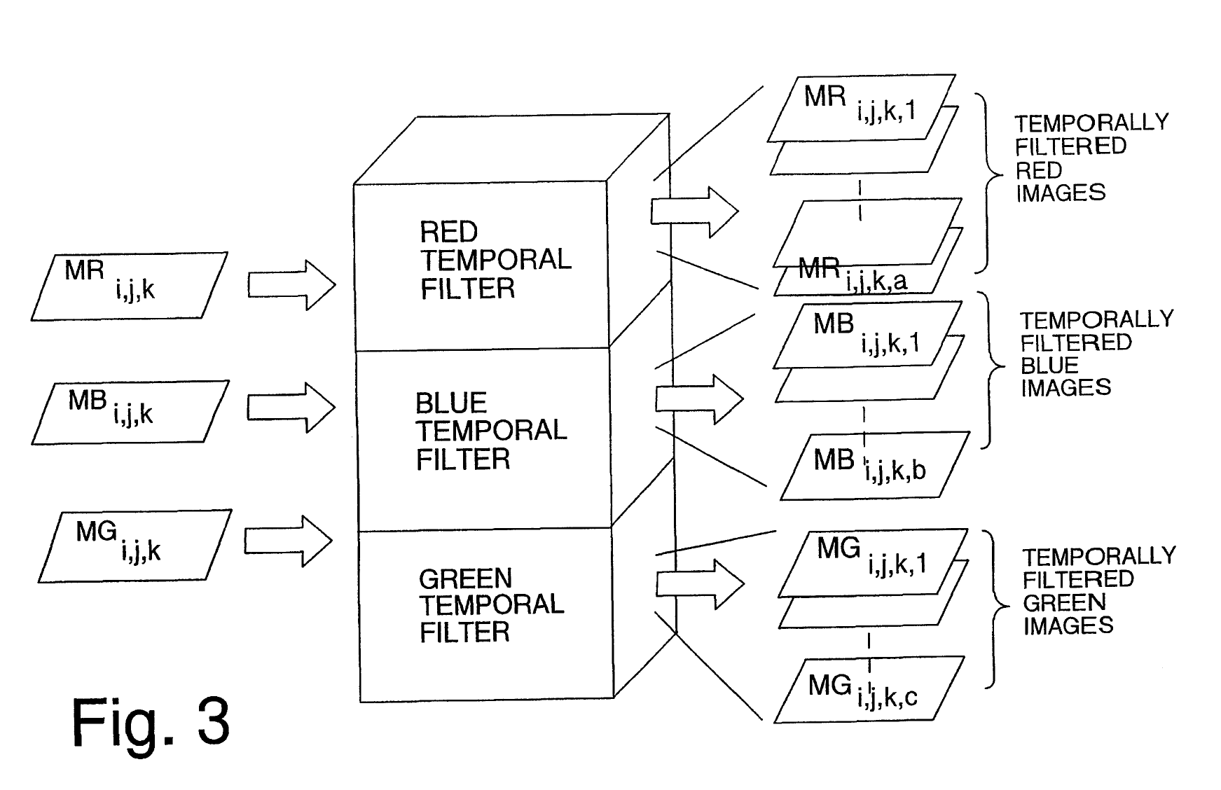

FIG. 3 is a pictorial representation of image temporal filtration executed by the smart camera in FIG. 1;

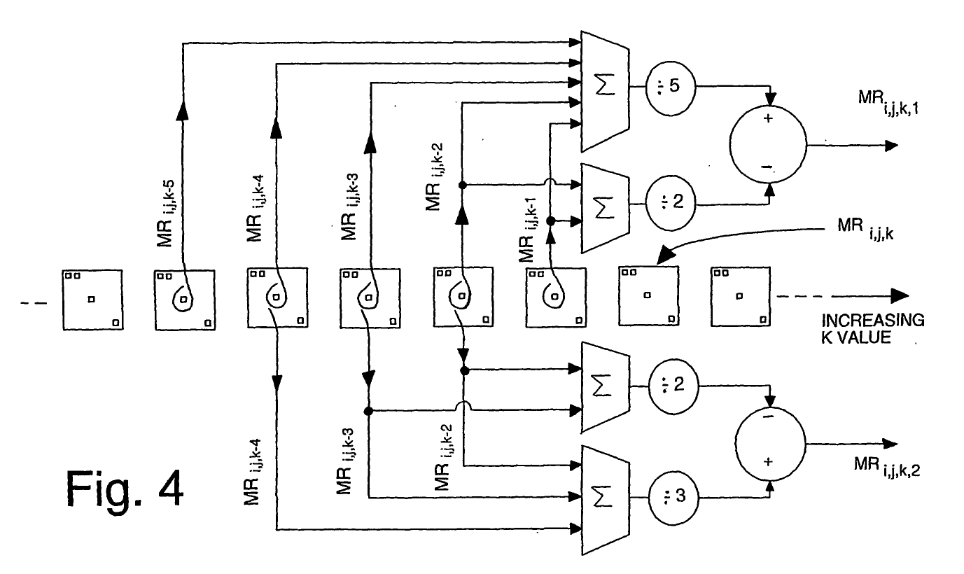

FIG. 4 is a pictorial representation of generation of filtered image data sets on an individual pixel basis;

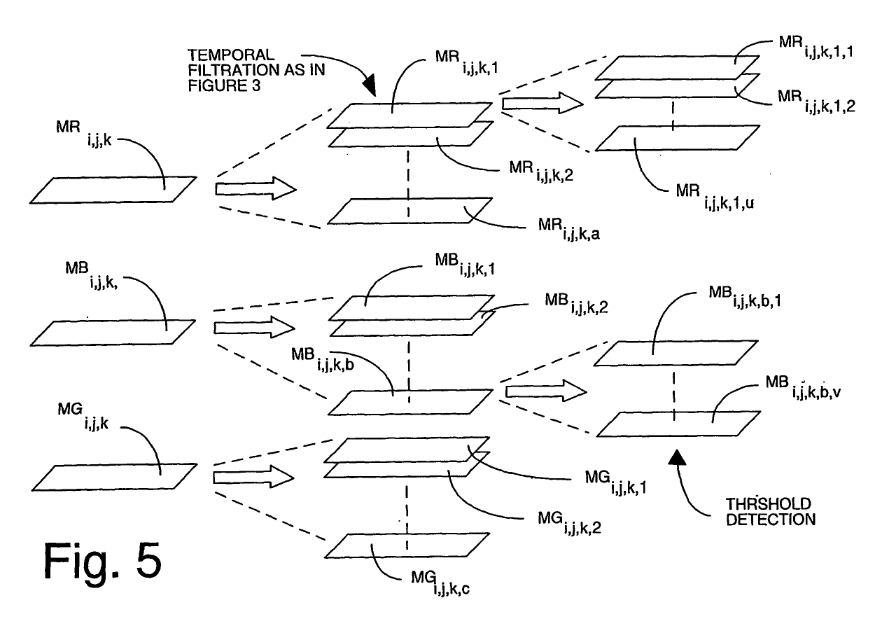

FIG. 5 is an illustration of mappings from the image data sets to temporally filtered data sets and subsequently to threshold image data sets;

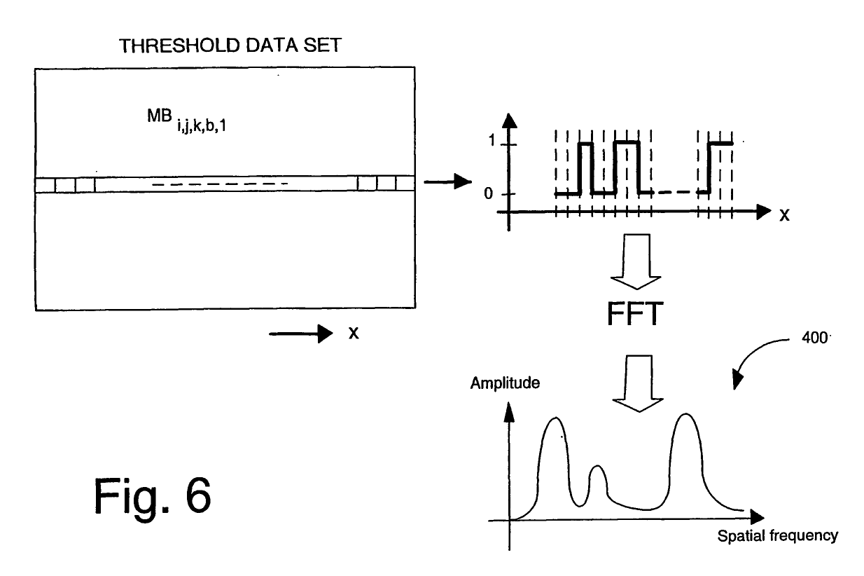

FIG. 6 is an illustration of spatial Fast Fourier Transform applied to a row of pixel data to identify a characteristic signature of events;

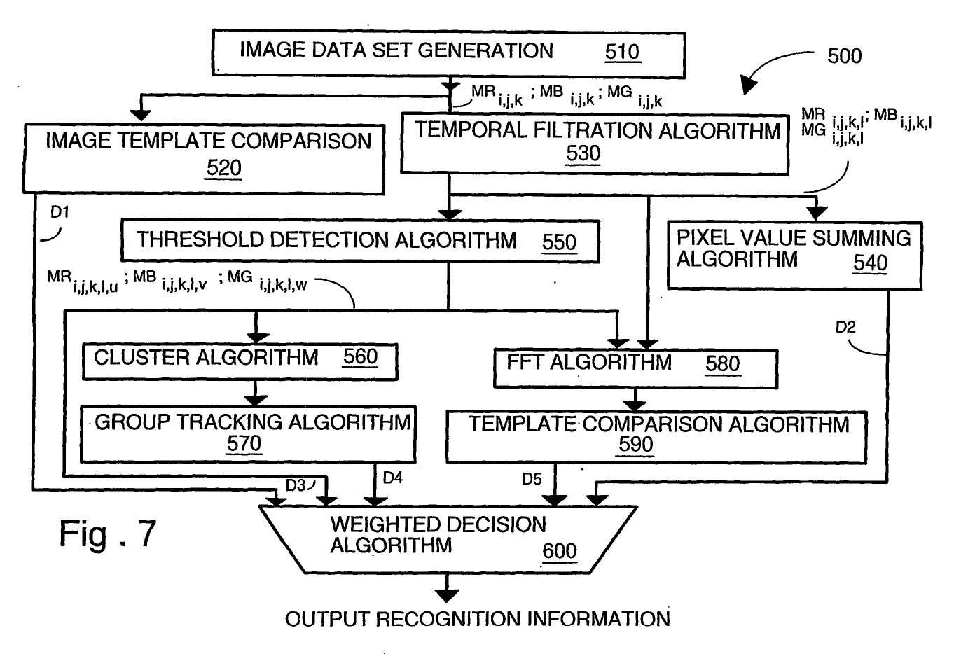

FIG. 7 is a schematic diagram of image processing steps executable within the smart camera of FIG. 1; and

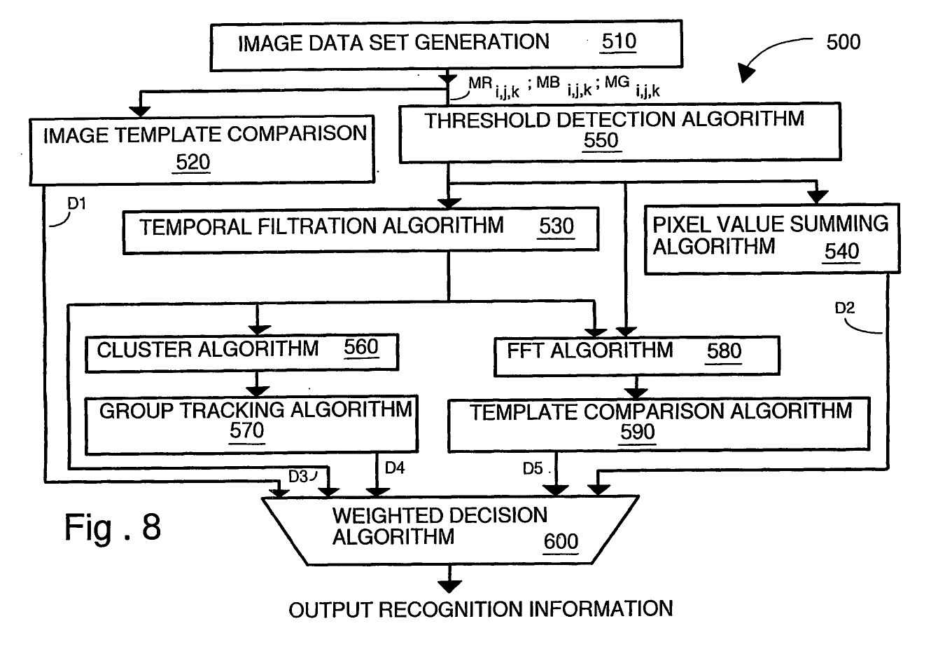

FIG. 8 is a schematic diagram of image processing steps executable within the smart camera of FIG. 1 in a different order to those depicted in FIG. 7.

### DESCRIPTION OF EMBODIMENTS OF THE INVENTION

Referring firstly to FIG. 1, there is shown a schematic illustration of a smart camera system indicated generally by 10. The system 10 comprises a smart camera 20 connected to an associated modem 30 at a customer's premises. The system 10 is directed as monitoring a scene, denoted by “S”, forming part of the premises.

The camera 20 and its modem 30 are coupled via a first bi-directional communication link 40 to a service provider 50. The link 40 can comprise one or more of at least one internet connection, at least one telephone connection line, at least Ethernet connection, at least one radio frequency connection, at least one optical connection such as optical fibre waveguides, at least one ADSL connection, at least one WAP mobile telephone connection and at least one direct microwave satellite connection. The provider 50 is also coupled via a second bi-directional communication link 60 to the customer 70.

Optionally, a direct link 80, for example an Ethernet link, is provided between the camera 20 and the customer 70 so that the customer 70 can view the scene “S” independently from the service provider 50.

The camera 20 and its associated modem 30, the service provider 50 and the customer 70 are preferably at mutually different locations. They may, for example, be thousands of km apart where the customer travels away from the United Kingdom on business in the United States and wishes to ensure that his/her premises in the United Kingdom are secure.

Alternatively, the system 10 can be implemented within the confines of a single premises: for example, the premises can be a factory complex comprising a cluster of neighbouring buildings of where the service provider 50 is a sub-contracted security firm, the customer 70 is a senior employee of the proprietor of the factory complex provided with lap-top computer with internet connection and the camera 20 corresponds to a plurality of smart cameras distributed at key viewing points around the factory complex.

The system 10 will now be described in overview in a number of ways.

Firstly, component parts of the smart camera 20 will be described.

The camera 20 comprises imaging optics 100 mounted with respect to a CCD-type pixel array image sensor 110. The sensor 110 can alternatively be a CMOS-type pixel array sensor. An electrical signal output of the sensor 110 is connected to an input P1 of data processing hardware 120. An output P2 of the processing hardware 120 is coupled to an input P3 of an interface 130. The camera 20 further comprises a processor 140, for example a 16-bit microcontroller, coupled via a bidirectional connection to the processing hardware 120 and also to an input/output port P4 of the interface 130 as shown. An input/output port P5 of the interface 130 is coupled via the modem 30, for example a telephone FSK modem or an internet-compatible modem, to a first end of the communication link 40. A second end of the link 40 is connected to a first bidirectional input/output port of a modem 140 at the service provider's site 50.

At the service provider's site 50, there is included a service provider's computer 150 where the provider's personnel can input control instructions and system configuration data for example. The computer 150 is also capable of providing advanced image processing which is not executable on the smart camera 20 because of its relatively simpler hardware. The modem 140 is further coupled via the link 60 to the customer 70 who is equipped with his/her own modem and associated PC.

The processing hardware 120 can be implemented as an FPGA. Similarly, the processor 140 can be a proprietary device such as a suitable 16-bit Intel, Motorola or Hitachi microcontroller. Preferably, the camera 20 and its modem 30 are housed within a single enclosure, for an enclosure mountable on domestic interior walls or exterior house walls. Alternatively, the imaging optics 100 and the sensor 110 can be a standard Proprietary camera unit, and the processing hardware 120, the Processor 140 and the modem 30 can be in a separate add-on unit, for example in the manner of a computer dongle, connected between the proprietary camera unit and, for example, a telephone and/or internet socket. Such a dongle arrangement is of advantage in that costs can be reduced by using standard mass-produced solid-state cameras.

Although the processor 140 is described as being a microcontroller, it can alternatively be a field programmable gate array (FPGA) or custom designed part with memory registers for storing configuration data.

Secondly, installation of the smart camera 20 will now be described.

When the customer 70 initially decides to install the smart camera 20 and its associated modem 30 onto his/her premises, he/she contracts the service provider 50 to undertake such installation. The customers 70 then selects a range of services which he/she wants to receive from the service provider 50. Both installation of the camera 20 and the provision of the range of services involve payment from the customer 70 to the service provider. If required, the payment can be implemented electronically to debit the customer's 70 bank account.

The service provider 50 next proceeds to download one or more of appropriate software and associated data parameters from the computer 150 via the link 40 to the smart camera 20 which stores the software and parameters as appropriate in non-volatile memory, for example electrically erasable read only memory (EEPROM) associated with the processor 140. The software and the parameters are used when the camera 20 is operating to process images in the processing hardware 120.

The range of services selected will determine how data provided via the link 40 is handled in the computer 150. For example:

(a) in a first type of service, the customer 70 requests software and associated parameters to be loaded into the camera 20 appropriate to detecting smoke and/or fire. The service provider 50 then configures the computer 150 so that when fire and/or smoke is detected at the customer's 70 premises and communicated via the link 40 to the computer 150, the service provider 50 simultaneously contacts the customer 70 via the link 60 and simultaneously calls emergency fire services to extinguish the fire and/or smoke;

(b) in a second type of service, the customer requests software and associated parameters to be loaded into the camera 20 appropriate to detecting smoke. The service provider then configures the computer 150 so that when smoke is detected at the customer's premises and communicated via the link 40 to the computer 150, the service provider instructs the camera 20 to output compressed real-time images of the scene “S” to the customer 70 so that the customer 70 can decide whether or not emergency fire services should be summoned. Such services can be summoned, for example, by the customer 70 responding back to the computer 150 via the link 60 so that the service provider 50 can then proceed to call emergency services;

(c) in a third type of service, the customer 70 requests software and associated parameters to be loaded into the camera 20 appropriate to detecting intruders. The service provider than configures the computer 150 so that when the motion of a person at the customer's premises occurs at a time when the customer is not scheduled to be at the premises, such motion is identified by the camera 20 which communicates in such an event to the computer 150 via the link 40. The computer 150 then communicates back to the camera 20 to send compressed real-time images to the computer 150 which then performs of advanced image processing on the real time images to determine whether or not the intruder is moving in a manner typical of an intruder, for example at haste in a rushed jerky manner. If the movement is typical of the customer 70, the computer 150 determines that the intruder is likely to be the customer or someone authorised by the customer. Conversely, if the movement is a typical for the customer and nervous, the computer 150 identifies that it is likely to be an intruder and proceeds to call the police to apprehend the intruder.

It will be appreciated that a large selection of potential services can be provided from the service provider 50. If necessary, these services can be dynamically varied at the request of the customer 70. For example, if the customer 70 is absent on overseas business trips, the service provider 50 can be instructed to provide a higher degree of surveillance to the customer's premises and automatically summon emergency services in the event of problems without consulting the customer; such increased surveillance could include a combination of smoke, fire, intruder and water leak detection based on the smart camera 20.

Thirdly, operation of the smart camera 20 will now be described in more detail.

The scene “S” is emits and/or reflects ambient optical radiation which propagates to the imaging optics 100 which projects an image of the scene “S” onto the sensor 110. The sensor 110 comprises a 2-dimensional pixel array which receives the image and generates a corresponding signal, for example in analogue PAL format, which passes to the processing hardware 120 whereat it is digitised and processed to provide output data, when appropriate, to the interface 130 for communication via the modem 30 and the link 40 to the computer 150. The processor 140 executes software loaded thereinto and controls the nature of the signal processing occurring in the processing hardware 120.

When the system 10 is in operation, it is important that it is relatively inexpensive, especially in the manner in which it employs the link 40. In normal operation, data is infrequently communicated via the link 40. When the link is a telephone connection, the camera 20 periodically, for example every 5 minutes, telephones to the service provider 50. The service provider 50 does not accept the call but monitors that a call has been attempted and notes the time each call was made from the camera 20. As a consequence of the provider 50 not accepting the call, the customer 70 does not incur any line-charge cost for the call. If the provider 50 fails to receive a call from the camera 20 at regular intervals, the provider assumes that a fault has developed at the camera 20, for example the processor 140 has “locked-up” and needs resetting, or an intruder has vandalised the camera 20. In the event of an unexpected fault with the camera 20, the computer 150 telephones to the camera 20 and instructs the camera 20 to respond back with its status information providing diagnostic details of the camera 20 function; in such a situation, a cost is incurred as the camera 20 accepts the call from the service provider 50. In an event of the camera 20 not responding when requested, the computer 150 assumes thereby that a serious fault has occurred and calls the customer 70 and/or raises an alarm with the police for example.

When the camera 20 detects an event in normal operation, for example a fire, it calls the service provider 50 for an extended duration. As the camera 20 calls for a longer period than it would when performing its regular checking call, the service provider 50 accepts the call, interprets data from the camera 20 and then decides whether to instruct the camera 20 to send real-time images or to contact the customer 70 and/or emergency services immediately.

If required, the link 40 can comprise a plurality of telephone lines, a first line allocated for regular checking calls from the camera 20, and a second line allocated for the camera 20 to call when an incident is identified. The service provide 50 will then immediately be aware that a serious incident has occurred when the camera 20 calls on the second line.

If required, more advanced modes of communication such as Asynchronous Digital Subscriber Line (ADSL) can be employed to link the camera 20 via its modem 30 to the service provider 50. Such advanced modes of communication are of advantage in that they incur substantially fixed line charges irrespective of the duration of use. Such a fixed cost is of benefit in that the link 40 can be continuously maintained allowing more frequent communication from the camera 20 to one or more of the service provider 50 and the customer 70.

Referring now to FIG. 2, there is shown the array image sensor 110. The sensor 110 comprises a 2-dimensional array of photodetector pixels denoted by C_{i,j} where indices i, j denote the spatial position of each pixel within the sensor 110 along x and y axes respectively. The array comprises 320×220 pixels such that index i is an integer in a range of 1 to 320, and index j is an integer in a range of 1 to 220 as illustrated in FIG. 2. On account of the sensor 110 being a colour device, each pixel generates red (R), blue (B) and green (G) intensity data.

When the sensor 110 is read out in operation, it results in the generation of corresponding three arrays of data values in memory of the data processing hardware 120, the arrays being denoted by MR_{i,j} for pixel red intensity data, MB_{i,j} for pixel blue intensity data, and MG_{i,j} for pixel green intensity data.

As the sensor 110 is outputting data corresponding to temporally successive images of the scene “S”, the pixels of individual images are denoted by a third index, namely MR_{i,j,k} for temporally successive pixel red intensity data, MB_{i,j,k} for successive pixel blue intensity data, and MG_{i,j,k} for successive pixel green intensity data. The index k is incremented with th passage of time. For example, the sensor 110 can be configured to output a complete image data set at 0.5 second intervals: other output intervals are possible, for example in a range of 10 msec to 1000 seconds depending upon application. However, output intervals in a range of 0.1 seconds to 10 seconds are more appropriate for domestic environments and similar indoor environments. Moreover, the pixel values are preferably numbers in a range of 0 to 255 corresponding to 8-bit resolution in order not to use excessive amounts of memory within the processing hardware 120.

The processing hardware 120 is arranged to perform temporal filtration on successive image data sets and generate a plurality of corresponding dynamically changing temporally filtered image data sets as depicted pictorially in FIG. 3. Thus, the red image data set MR_{i,j,k} is mapped onto “a” filtered image data sets denoted by MR_{i,j,k,l} where an index l is in a range of 1 to “a” corresponding to different filter time constants. Likewise, the blue image data set MB_{i,j,k} is mapped onto “b” filtered image data sets denoted by MB_{i,j,k,l} where the index l here is in a range of 1 to “b” corresponding to different filtered time constants. Similarly, the green image data set MG_{i,j,k} is mapped onto “c” filtered image data sets denoted by MG_{i,j,k,l} where the index l here is in a range of 1 to “c” corresponding to different time constants.

The temporal filtration applied by the data processor 120 to the data sets MR_{i,j,k}, MB_{i,j,k}, MG_{i,j,k} preferably corresponds to temporal bandpass filtration to the signal of each pixel from the sensor 110; however, other types of temporal filtration can be employed, for example highpass filtration. Each of the values of the index l in FIG. 3 corresponds to a different filtration time constant. The time constants selected and values for “a”, “b” and “c” are defined by the provider's computer 150 when remotely configuring the camera 20.

For example, in FIG. 4 there is depicted for a pixel generation of two mapped filtered image data sets for red pixel data. A first filtered image data set corresponds to a subtraction of the sum of the images k-1, k-2, k-3, k-4, k-5 normalised by scaling by a factor 5 and the sum of the images k-1, k-2 normalised by scaling by a factor 2. A second filtered image data set corresponds to a subtraction of the sum of the images k-2, k-3, k-4 normalised by scaling by a factor 3 and the sum of the images k-2, k-3 normalised by scaling by a factor 2. Other combinations of subtraction are possible from previous image data sets to obtain specific temporal filtration characteristics. If required, different weighting coefficients can be employed. Image data no longer required for temporal filtering purposes are deleted to free random access memory within the camera 20 for future image data sets.

The temporally filtered data sets are useful in that they allow pixel data corresponding to events occurring within specific time frames to be isolated. Moreover, in view of such filtration being applied to one or more of red, blue and green image data sets, specific types of events can be identified. For example, flames in the scene “S” tend to flicker at a frequency predominantly around 1 Hz and are red in colour. Thus, the camera 20 can be programmed to generate a filtered data set corresponding to flame and then sum the value of the pixels within the filtered image data set. If this value exceeds a threshold value, the camera 20 can be programmed to signal this as the presence of fire to the computer 150.

The camera 20 can be programmed to sum pixel values in several temporally filtered data sets using different weighting coefficients to emphasise certain data sets relative to others. Such weighting coefficients can be dynamically loaded from the service provider's computer 150 when initially or subsequently dynamically configuring the camera 20.

The camera 20 can be programmed to analyse the temporally filtered image data sets in various configurations to predict the occurrence of several events concurrently, for example the presence of fire, smoke and intruders as could potentially occur in an arson attack. People moving have a characteristic frequency of motion which will be more noticeable in certain of the temporally filtered image data sets, for example an intruder's legs will move more rapidly than his/her torso.

The processor 140 can be further programmed to instruct the processing hardware 120 to apply threshold detection to one or more of the temporally filtered data sets MR_{i,j,k,l}, MB_{i,j,k,l}, MG_{i,j,k,l}. Thus, as depicted in FIG. 5, each of these filtered data sets is mapped onto a one or more threshold data sets depending on pixel value in the filtered data set. Each data threshold set has associated therewith a threshold value loaded into the processor 140 from the service provider's computer 150 when configuring the camera 20. For example, when 8-bit pixel digitization is employed providing pixel values from 0 to 255, threshold levels can be set at 10, 20, 40, 80, 100, 120, 150, 200, 255 giving rise to nine threshold data sets from one corresponding temporally filtered data set.

For a given pixel in a threshold data set having a threshold value T, for example a pixel MR_{i,j,k,l,1}, if a pixel MR_{i,j,k,l} of the corresponding temporally filtered data set exceeds the value T, a unity value is allotted to the pixel MR_{i,j,k,l,1}, otherwise a zero value is allotted thereto. Such a binary form to the threshold data set results in efficient use of camera 20 memory as the image data sets can, depending upon configuration data loaded into the camera 20, give rise to a correspondingly large number of threshold data sets. If required, the camera 20 can be provided with an auto iris to provide normalisation of pixel values in the filtered data sets so that detection of events using the camera 20 is less influenced by levels of general ambient illumination applied to the scene “S”.

The mapping of filtered image data sets onto corresponding threshold data sets allows characteristics of certain types of event in the scene “S” to be more accurately isolated. For example, billowing smoke in the scene “S” can thereby be better distinguished from more rapidly altering flames by virtue of colour, frequency and threshold value characteristics.

If required the processor 140 can be programmed to monitor for the occurrence of certain types of events concurrently in one or more species of the data filter image sets, for example corresponding to green pixel data, and also in one or more of the threshold image data sets corresponding to red pixel data.

In order to further discriminate occurrence of certain types of event, the number of abutting groups of pixels of unity value and the number of pixels of unity value of these groups can be determined by way of applying a clustering algorithm to one or more of the threshold data sets. For example, an intruder moving about in the scene “S” will give rise to a relatively large grouping of pixels moving as a single entity which can be positionally tracked and recorded by the processor 140 for reporting to the service provider 50 and the customer 70; the threshold data set in which the relatively large grouping occurs will depend upon the colour of clothing worn by the intruder, this colour potentially being valuable forensic evidence for use in police conviction of the intruder. Scattered events, for example where the camera 20 is directed towards a leafy bush rustling in the wind, will give rise to numerous small groupings of pixels of unity value in the threshold data sets and hence, by applying a threshold value for grouping pixel number, it is possible to differentiate between a person moving in a scene even when such movement is relative to a general rustling type of motion within the scene “S”.

In order to further distinguish scattered events within one or more of the threshold image data sets, one or more rows or columns of pixels therein can be preferentially selected and fast Fourier transform (FFT) applied thereto as depicted in FIG. 6 to generate one or more corresponding spatial frequency spectra, for example a spectrum as indicated by 400. If required, other types of spatial frequency transform, for example Laplaclan transform, can be employed in preference to a FFT. The processor 140 is preferably programmed to compare this spectrum 400 with a template spectrum downloaded to the camera 20 from the service provider's computer 150 corresponding to a particular type of event within the scene “S”. When a sufficiently satisfactory match between the spatial spectra and one or more of the templates is obtained, the camera 20 can use occurrence of this match to signal to the service provider 50 that a particular type of event has occurred within the scene “S”. If required, successive spatial frequency spectrum can be average and/or correlated to obtain an even more reliable indication of the occurrence of a specific type of event.

In the foregoing, it will be appreciated that certain regions of the image data sets MR_{i,j,k}, MB_{i,j,k}, and MG_{i,j,k} can be preferably masked so that they are not subsequently processed. Alternatively, if the processor 140 detects an event occurring in a particular part of the scene “S”, the processor 140 can be configured to preferentially output specific parts of the data image sets to the service provider 50 for more thorough analysis using the computer 150. Such an approach is especially relevant where the camera 20 is employed to identify personnel, for example at a security access door or a bank cash machine, where an image of solely a person's face can be sent the service provider's computer 150 for more thorough image analysis to ensure reliable authorisation of access.

Referring finally to FIG. 7, there is shown a flow diagram indicated generally by 500. The flow diagram 500 depicts processing steps performed by the processing hardware 120 in conjunction with the processor 140 as described individually in the foregoing. An image data set generation step 510 corresponds to generation of the data sets MR_{i,j,k}, MB_{i,j,k}, MG_{i,j,k}. The smart camera 20 can be configured to directly compare these data sets against one or more image templates and determine a best match in a image template comparison step 520, for example by correlation, to determine whether or not a particular type of event has occurred within the scene “S”. If a match is found against one or more of the templates, an output D1 is set to values indicative of the closeness of the match and the particular template concerned, a zero value corresponding to no match found. The template comparison step 510 can perform specialist operations such as determining aspect ratio of a feature in part of the image, for example to determine whether the feature corresponds to a person standing upright where height-to-width aspect ratio will fall within an expected range downloaded to the camera 20. Moreover, the template comparison step 520 is effective at identifying the presence of an optical marker target within the scene “S” which, for example, can be used for labelling items so that they are recognised by the camera 20. Such tagging is of benefit when a high-value item is included and tagged in the scene “S” where theft of the item would be serious loss.

A temporal filtration step 530, for example as depicted in FIG. 4, is applied to the image data sets to generate one or more temporally filtered image data sets MR_{i,j,k,l}, MB_{i,j,k,l}, MG_{i,j,k,l}. The processor 140 and the processing hardware 150 can be configured to analyse in a pixel summing algorithm step 540 one or more of these filtered image data sets directly, for example by summing the value of pixel data therein, and also to generate therefrom a figure of merit from one or more of the data sets. Such a figure of merit can be expressed for example by Equation 1 (Eq. 1):

D2=A1.SUM1+A2.SUM2+ Eq. 1

where

D2=figure of merit;

A1, A2, . . . =customising coefficients loaded into the processor 140 from the computer 150; and

SUM1, SUM2=sum of pixel values in first, second, filtered image data sets.

The figure of merit D2 is output as shown.

The filtered data sets are passed to a threshold detection algorithm step 550 where the filtered images are compared against one or more threshold values to generate corresponding threshold data sets. The step 550 is operable to sum the number of pixels of non-zero value in each of the threshold data sets and output these sums as an output D3.

One or more of the threshold data sets are analysed in a cluster algorithm step 560 which identified groupings of abutting pixels of non-zero value and determines where the groupings occur within the scene “S” and the number of pixel groupings which have more than a threshold number of pixels therein. As described in the foregoing, such groupings can correspond to an intruder moving within the scene “S”. In an associated step 570, movement of groupings within the scene “S” are tracked and a corresponding output D4 generated which is indicative of the type of events occurring within the scene “S”. The step 570 can perform specialist operations such as determining aspect ratio of a grouping in part of the image, for example to determine whether the feature corresponds to a person standing upright where height-to-width aspect ratio will fall within an expected range downloaded to the camera 20.

If required, the group tracking algorithm step 570 can be implemented at the service Provider's computer 150, for example where the link is an ADSL link capable of supporting continuous communication from the camera 20 to the service provider 50 at fixed line charge rates irrespective of use.

One or more of the threshold detection data sets is processed in a FFT algorithm step 580 where one or more columns and/or rows of pixels, or even oblique rows of pixels, in one or more of the threshold detected data sets are subjected to spatial FFT filtration to generate one or more corresponding spectra which are compared against spectra templates loaded into the camera 20 from the service pmvider's computer 150 in a template comparison algorithm step 590 to identify the likelihood of one or more events occurring within the scene “S”; an output D5 indicative of correlation of the spectra is output from the step 590.

Finally, the five outputs D1 to D5 are received at a weighted decision algorithm step 600 which performs an analysis of the likelihood of one or more events in the scene “S” having occurred. For example, if four out of five of the outputs D1 to D5 indicate that a particular type of event, for example fire, has occurred within the scene “S”, the step decides that that there is a high probability the event has occurred and proceeds to communicate this decision to the service provider's computer 150.

If required, the FFT algorithm step 580 can operate directly on data sets output from the temporal filtration algorithm step 530 thereby bypassing the threshold detection algorithm step 550.

It will also be appreciated that the algorithm steps depicted in FIG. 7 can be implemented in a different sequence in order to considerably reduce memory storage capacity required. In FIG. 8, there is shown the threshold detection algorithm step 550 implemented prior to the temporal filtration algorithm step 530.

If required, the camera 20 can be arranged to output the image data sets from step 510 directly via the modem 30 and the link 40 to the service provider 50. Such direct connection is desirable where an event has been identified and one or more of the service provider 50 and the customer 70 want to monitor the scene “S” in real time; such real time monitoring is desirable in the event of a burglary where continuous moving image data is required for legal evidence.

It will be appreciated that the smart camera 20 is sufficiently flexible to allow one or more of the algorithms depicted in FIGS. 7 and 8 to be downloaded from the service provider 50. Such downloading is important when software upgrades are to be implemented by the service provider 50, and/or performance of the camera 20 is to be enhanced at request of customer 70 in response to a payment for enhanced services. Moreover, data parameters for use in identifying specific types of event in steps 520, 530, 550, 590, 600 need to be updated when the detection characteristics of the camera 20 are to be altered, for example at request and payment by the customer 70.

The smart camera 20 has numerous alternative applications to those described in the foregoing for monitoring domestic. Industrial or business premises. The camera 20 can also be used in one or more of the following applications:

(1) for traffic flow monitoring, for example to modify traffic light characteristics in response to traffic density and pedestrian movement,

(2) for monitoring aircraft exterior surfaces to provide early warning of structural or engine failure;

(3) for security purposes in association with automatic cash machines, for example to assist determining authorisation of a person to withdraw cash from a bank account;

(4) for child monitoring purposes in domestic or school environments;

(5) for automobile black box applications, for example to provide court evidence of a vehicle's trajectory immediately Prior to a vehicular impact situation;

(6) for product quality control checking during manufacture, for example quality sorting near more of vegetables and fruits in a food packaging and processing facility;

(7) for monitoring vehicle and customer movement at petrol stations;

(8) for monitoring weather conditions, for example monitoring cloud formations to assist with predicting the onset of precipitation;

(9) for monitoring patient movement in hospitals and similar institutions;

(10) for monitoring prisoner movements within prisons; and

(11) for monitoring machinery susceptible to repetitive cyclical movement to determine fault conditions, for example in a bottling plant where bottles are transported at a substantially constant rate along conveyor belts and filled by filling machines in a cyclically repetitive manner; by such an approach, a single smart camera can monitor a complete production line, different operations within the production line having mutually different temporal frequencies and thereby providing groupable pixel changes in specific associated threshold data sets within the camera 20.

Although the links 40, 60 are described as being either telephone links or internet links, it will be appreciated that the smart camera 20 can employ one or more of radio links, for example as employed in contemporary WAP mobile telephones, microwave wireless links, and optically modulated data links either through optical fibres or my free-space modulated optical beam propagation.

The steps 520, 590, 600 at least are susceptible to being implemented in the form of programmable neural networks.

Although the sensor 110 is a colour device, it will be appreciated that the camera 20 can also be implemented using a black/white pixel imaging device although discrimination of vent types is expected to inferior to when the colour device is employed. Moreover, although the sensor 110 is described in the foregoing as outputting red, blue and green pixel information, the sensor 110 can alternatively be configured to output other colour combinations, for example yellow, cyan and magenta data.

The sensor 119 may be implemented as an infra red (IR) sensitive detector. Preferably, the sensor 110 is sensitive to both naked-eye visible radiation and IR radiation. Such an IR detector is appropriate when the smart camera 20 is employed for night surveillance purposes, for example to monitor intruders, and for ire monitoring purposes, for example to detect electrical hot-spots in electrical wiring networks. The sensor 110 could comprise one or more of a microchannel plate IR detector, for example an IR image intensifier, and a cadmium mercury telluride (CMT) pixel array solid state detector.

Thus, the inventors have devised an alternative method of image processing which is more versatile for identifying a wide range of events within scenes. Moreover, the method is susceptible to rapid modification to identify preferred types of events within scenes. Furthermore, the inventors have appreciated that such a more versatile method can be used in smart cameras, namely electronic cameras with in-built processing hardware. Such cameras can be coupled to the telephone network and/or internet and can be relatively easily reconfigured using parameters and software modules downloaded via the aforesaid telephone network and/or internet. Such reconfigurement enables customers to choose dynamically different categories of events which they wish to automatically monitor without regular intervention.

1. A smart camera (20) including:
(a) a pixel sensor (110);
(b) optical imaging means (100) for projecting an image of a scene onto the sensor (110) to generate a sensor signal representative of the scene; and
(c) processing means (120, 140) for processing the sensor signal to identify whether or not one or more events occur within the scene and for outputting an output signal indicative of occurrence of one or more of the events to a communication channel coupled to the processing means,
characterised in that the camera (20) includes communicating means (30, 130) for remotely updating at least one of operating parameters and software of the processing means (120, 140) for modifying operation of the camera for identifying the events.

2. A camera (20) according to claim 1, wherein the processing means includes:
(a) filtering means (530) for temporally filtering the sensor signal to generate a plurality of corresponding motion indicative filtered data sets; and
(b) analysing means (540, 550, 600) for analysing the filtered data sets to determine therefrom occurrence of one or more events in the scene.

3. A camera (20) according to claim 2, wherein the processing means includes:
(a) threshold detecting means (550) for receiving one or more of the filtered data sets and generating one or more corresponding threshold data sets indicative of whether or not pixel values within said one or more filtered data sets are greater than n r more threshold values; and
(b) clustering means (560) for associating mutually neighbouring pixels of nominally similar value in the one or more threshold data sets into one or more pixel groups and thereby determining an indication of events occurring in the scene corresponding to the one or more pixel groups.

4. A camera (20) according to claim 1, wherein the processing means includes:
(a) threshold detecting means (550) for receiving the sensor signal to generate a plurality of image data sets and then to generate from said image data sets corresponding threshold data sets indicative of whether or not pixel values within the image data sets are greater than one or more threshold values; and
(b) clustering means (560) for associating mutually neighbouring pixels of nominally similar value in the one or more threshold data sets into one or more pixel groups and thereby determining an indication of events occurring in the scene corresponding to the one or more pixel groups.

5. A camera (20) according to claim 4, wherein the processing means includes:
(a) filtering means (530) for temporally filtering one or more of the threshold data sets to generate a plurality of corresponding motion indicative filtered data sets; and
(b) analysing means (540, 550, 600) for analysing the filtered data sets to determine therefrom occurrence of one or more events in the scene.

6. A camera (20) according to claim 3, 4 or 5, further comprising tracking means for tracking movement of said one or more groups within the scene and thereby determining one or more events indicated by the nature of the movement.

7. A camera (20) according to claim 3, 4, 5 or 6, further comprising measuring means for measuring aspects ratios of said one or more groups to determine more accurately the nature of their associated event within the scene.

8. A camera (20) according to claim 3, 4 or 5, further comprising:
(a) transforming means (580) for executing a spatial frequency transform on at least part of the threshold data sets and/or the filtered data sets to generate one or more corresponding spectra; and
(b) analysing means for comparing one or more of the spectra with one or more corresponding reference spectral templates to determine the nature of events occurring within the scene.

9. A camera (20) according to any one of the preceding claims, further comprising voting means (600) for receiving a plurality of event indicating parameters in the processing means (120, 140) and determining one or more most likely events therefrom that are probably occurring within the scene.

10. A camera (20) according to any one of the preceding claims, wherein there are means for dynamically modifying one or more of the operating parameters and software when the camera is in use.

11. A camera (20) according to any one of the preceding claims, further comprising modem interfacing means operable to communicate at intervals a signal through a single channel that the camera is functional, and to communicate for a relatively longer period through the single channel when one or more events are identified in the scene.

12. A camera (20) according to any one of claims 1 to 10, wherein the interfacing means is operable to communicate at intervals a signal through a first channel that the camera is functional, and to communicate through a second channel when on or more events are identified in the scene.

13. A camera (20) according to any one of the preceding claims, wherein the sensor (110) is a colour imaging device, and the camera (20) is arranged to process pixel image data separately according to their associated colours.

14. A method of performing image processing in a camera according to any one of the preceding claims, the method including the steps of:
(a) projecting an image of a scene onto a pixel sensor of the camera to generate a sensor signal representative of the scene; and
(b) processing the sensor signal to identify whether or not one or more events occur within the scene and outputting an output signal indicative of occurrence of one or more of the events to a communication channel;
characterised in that the method further includes the step of:
(c) remotely updating at least one of operating parameters and software of the processing means as required for modifying operation of the camera for identifying the events.

15. A method according to claim 13, the method further comprising the steps of:
(a) temporally filtering the sensor signal to generate a plurality of corresponding motion indicative filtered data sets; and
(b) analysing the data sets to determine therefrom occurrence of one or more events in the scene.

16. A method according to claim 15, the method further comprising the steps of:
(a) receiving one or more of the filtered data sets and generating one or more corresponding threshold data sets indicative of whether or not pixel values within said one or more filtered data sets are greater than no or more threshold values; and
(b) associating mutually neighbouring pixels of nominally similar value in the threshold data sets into one or more pixel groups and thereby determining an indication of events occurring in the scene corresponding to the one or more groups.

17. A method according to claim 16, further comprising the step of tracking movement of said one or more groups within the scene and thereby determining one or more events indicated by the nature of the movement.

18. A method according to claim 15, 16 or 17, further comprising the steps of:
(a) executing a spatial Fourier transform on at least part of the threshold data sets to generate one or more corresponding spectra; and
(b) comparing one or more of the spectra with one or more corresponding reference spectral templates to determine the nature of events occurring within the scene.

19. A method according to any one of claims 14 to 18, further comprising the step of receiving a plurality of event indicating parameters and determining one or more most likely events therefrom that are probably occurring within the scene.

20. A method according to any one of claims 14 to 19, including the step of dynamically modifying one or more of the operating parameters and software can be dynamically modified when the camera is in use.

21. A method according to any one of claims 14 to 20, wherein a signal is communicated at intervals through a single channel to indicate that the camera is functional, and communicated for a relatively longer period through the single channel when one or more events are identified in the scene.

22. A method according to any one of claims 14 to 20, wherein a signal is communicated at intervals through a first channel to indicate that the camera is functional, and is communicated through a second channel when on or more events are identified in the scene.

23. A method according to any one of claims 14 to 22, wherein the sensor (110) is a colour imaging device, and the camera (20) is arranged to process pixel image data separately according to their associated colours.

24. A method of transferring one or more of operating parameters and software to a camera according to claim 1, the method comprising the step of remotely updating at least one of operating parameters and software of processing means of the camera as required for modifying operation of the camera when identifying the events.

25. A method of communicating between a smart camera according to claim 1 and a server site remote from the camera, the method comprising the step of communicating a signal at intervals through a single channel to indicate that the camera is functional, and communicating the signal for a relatively longer period through the single channel when one or more events are identified in the scene.

26. A method of communicating between a smart camera according to claim land a server site remote from the camera, the method comprising the step of communicating a signal at intervals through a first channel to indicate that the camera is functional, and to communicate the signal through a second channel when on or more events are identified in the scene.

27. A smart camera system including a remote server for providing one or more of operating parameters and software, and a smart camera according to any one of claims 1 to 17 coupled to the remote server for:
(a) one or more of receiving the operating parameters and the software from the server to determine camera operation; and
(b) monitoring a scene, the camera arranged to communicate to the remote server when one or more events occur within the scene.
